(19) United States
(12) Patent Application Publication
(10) Pub. No.: US 2012/0231152 A1
(43) Pub. Date: Sep. 13, 2012

(54) METHODS FOR PREPARING A COATING SOLUTION FOR PRODUCING A TRANSPARENT CONDUCTIVE FILM

(76) Inventors: Jyung-Dong LIN, Kaohsiung (TW); Cho-Liang Chung, Kaohsiung (TW); Ming-Wuu Hsu, Kaohsiung (TW); Yi-Hsuan Ho, Kaohsiung (TW)

(21) Appl. No.: 13/281,182

(22) Filed: Oct. 25, 2011

(30) Foreign Application Priority Data
Mar. 7, 2011 (TW) 100107579

(51) Int. Cl. B05D 5/12; B05D 1/18; H01B 1/12

(52) U.S. Cl. 427/58; 252/519.2; 252/519.21; 252/519.5

(57) ABSTRACT

A method for preparing a coating solution for producing a transparent conductive film includes dissolving a zinc precursor and a metal salt with a solvent to form a first solution containing the zinc precursor and a second solution containing the metal salt. The first solution is mixed with the second solution. At least one stabilizer is added into a mixture of the first and second solutions to form a coating solution precursor. The coating solution precursor is heated and stirred until even dissolution of the zinc precursor and the metal salt. The heated and stirred coating solution precursor is placed steadily in an environment having a temperature lower than a room temperature to undergo crystal growth, obtaining a raw coating solution. The raw coating solution is then filtered to obtain a coating solution.

### BACKGROUND OF THE INVENTION

1. Field of the Invention

The present invention relates to methods for preparing a coating solution for producing a transparent conductive film, and, more particularly, to methods for preparing a coating solution for increasing the transmittance of a transparent conductive film.

2. Description of the Related Art

Currently, transparent conductive films are widely used in photoelectric industries such as liquid displays, plasma displays, or touch panels. The transparent conductive films include metal films (such as gold, silver, aluminum, etc) and metal-oxide (such as zinc oxide, tin oxide, indium tin oxide, etc) semiconductor films. Metal films provide good electrical conduction but have poor transmittance. Thus, development of the metal-oxide semiconductor films is the main stream.

Taiwan Patent No. 1314760 discloses a method for preparing a transparent conductive film in which a substrate is submerged in a coating solution to form the transparent conductive film on a surface of the substrate. In this method, zinc acetate is dissolved in 2-propanol, and aluminum nitrate is dissolved in ethanol as aluminum doping. Then, the solution of aluminum nitrate is added into the solution of zinc acetate and 2-propanol, forming the coating solution after adequate stirring.

Before preparing the transparent conductive film with the coating solution, the coating solution is generally heated at a temperature between 70-80° C. and then placed steadily for two days at the room temperature to enhance the crystal growth in the coating solution for reducing the crystal boundaries and defects between crystalline grains. However, the crystal growing procedure is not monitored while the coating solution is placed steadily at the room temperature, causing the following problems during the crystal growth procedure. Firstly, since the growing speed of the crystalline grains is affected by the temperature at which the coating solution is steadily placed, the crystalline grains or particulates generated in the coating solution placed steadily at the room temperature have large diameters that cause uneven coating on the surface of the substrate during the coating procedure, adversely affecting the transmittance of the transparent conductive film. Secondly, to increase the procedural efficiency of the transparent conductive film, the coating solution is merely placed steadily for a short period of time before starting the subsequent coating procedure. The large crystalline grains or particulates still suspend in the coating solution such that the crystalline grains coated on the surface of the substrate have different sizes, significantly reducing the transmittance of the transparent conductive film and, hence, adversely affecting applications of the transparent conductive film on flat displays or touch panels.

Thus, a need exists for a novel method for preparing a coating solution for a transparent conductive film.

### SUMMARY OF THE INVENTION

An objective of the present invention is to provide a method for preparing a coating solution for producing a transparent conductive film to reduce the size difference of the crystalline grains by controlling the growing speed of the crystalline grains.

Another objective of the present invention is to provide a method for preparing a coating solution for producing a transparent conductive film to increase the transmittance of the transparent conductive film by removing larger crystalline grains or particulates in the coating solution.

The present invention fulfills the above objectives by providing a method for preparing a coating solution for producing a transparent conductive film. The method includes a preparing step, a crystal growing step, and a filtering step. The preparing step includes: dissolving a zinc precursor and a metal salt with a solvent to form a first solution containing the zinc precursor and a second solution containing the metal salt, mixing the first solution with the second solution, and adding at least one stabilizer into a mixture of the first and second solutions to form a coating solution precursor. The crystal growing step includes: heating and stirring the coating solution precursor until even dissolution of the zinc precursor and the metal salt, and steadily placing the heated and stirred coating solution precursor in an environment having a temperature lower than a room temperature to undergo crystal growth, obtaining a raw coating solution. The filtering step includes filtering the raw coating solution to obtain a coating solution.

The method can further include a treating step of submerging a substrate in the coating solution and pulling the substrate out of the coating solution after a surface of the substrate is coated with the coating solution.

Preferably, the temperature of the environment is in a range of 5-23° C.

Preferably, the coating solution precursor is steadily placed in the environment for 3-30 days in the crystal growing step.

Preferably, the raw coating solution is filtered with a 0.5 μm mesh in the filtering step to remove crystalline grains having diameters larger than 0.5 μm from the raw coating solution.

Preferably, the concentration of zinc precursor in the first solution is 0.1-1M, the concentration of metal salt in the second solution is 0.1-10 wt %, and a final concentration of said at least one stabilizer in the coating solution precursor is 0.1-2M.

Preferably, the at least one stabilizer is selected from the group consisting of monoethanolamine, diethanolamine, triethanolamine, and combinations thereof.

Preferably, the zinc precursor is zinc acetate dehydrate or zinc acetate anhydrous.

Preferably, the metal salt is aluminum nitrate or gallium nitrate.

Preferably, the solvent is 2-propanol.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a block diagram illustrating an example of a method for preparing a coating solution for producing a transparent conductive film according to the present invention.

FIG. 2 shows a block diagram illustrating another example of the method for preparing a coating solution for producing a transparent conductive film according to the present invention.

FIG. 3 shows a transmittance-wavelength diagram of transparent conductive films produced by two examples according to the present invention.

FIG. 4 shows a transmittance-wavelength diagram of transparent conductive films produced by another two examples according to the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

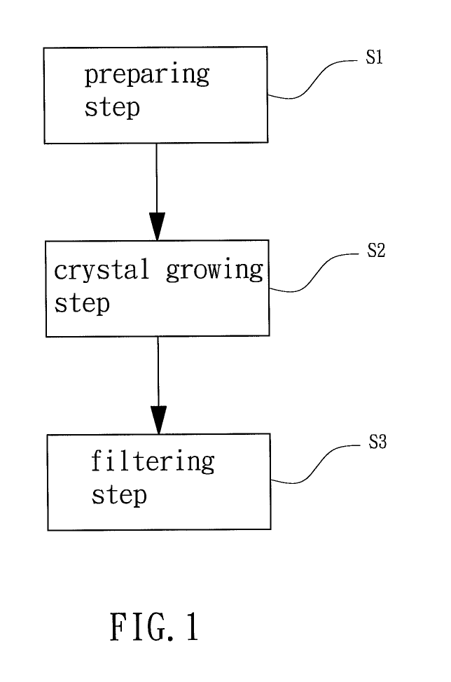

FIG. 1 shows an example for carrying out a method for preparing a coating solution for producing a transparent conductive film. The method of this example includes a preparing step S1, a crystal growing step S2, and a filtering step S3.

In the preparing step S1, a zinc precursor and a metal salt are respectively dissolved by a solvent to form a first solution containing the zinc precursor and a second solution containing the metal salt. The first and second solutions are mixed together, and at least one stabilizer is added to the mixture of the first and second solutions to form a coating solution precursor. Specifically, the zinc precursor is placed in the solvent to form the first solution, and the metal salt is dissolved in another solvent having the same composition as the solvent for the zinc precursor to form the second solution, avoiding adverse affect to subsequent coating due to early reduction reaction of the metal salt and the zinc precursor in the same solvent. The zinc precursor can be zinc acetate dehydrate, zinc acetate anhydrous, etc. The metal salt can be aluminum nitrate, gallium nitrate, indium chloride, etc. The solvent can be methanol, ethanol, 2-propanol, etc. Furthermore, after the at least one stabilizer is added into the mixture of the first and second solutions, the stabilizer accelerates the dissolution of the zinc precursor to form the coating solution precursor. The stabilizer can be monoethanolamine (MEA), diethanolamine (DEA), triethanolamine (TEA), etc. In this embodiment, two or more stabilizers are added to form the coating solution precursor to increase the stability of the coating solution precursor and to prolong the period of time in the subsequent storage. As an example, in this embodiment, zinc acetate is used as the zinc precursor, 2-propanol is used as the solvent, and the zinc acetate is added into 2-propanol to form the first solution containing 0.1-1M of zinc acetate. The metal salt is dissolved in 2-propanol to form the second solution containing 0.1-10 wt % of metal salt. After adequate mixing of the first and second solutions, at least one stabilizer is added into the mixture of the first and second solutions to form the coating solution precursor. The final concentration of the stabilizer in the coating solution precursor is 0.1-2M.

In the crystal growing step S2, the coating solution precursor is heated and stirred so that the metal salt and the zinc precursor dissolve evenly. The coating solution precursor is then placed steadily in an environment having a temperature lower than the room temperature to undergo crystal growth, obtaining a raw coating solution. Specifically, the coating solution precursor is liable to dissociate into zinc ion and acid radical during the heating procedure. The acid radical reacts with the metal salt to generate a nanometric-scale gel. The coating solution precursor is then placed steadily at a temperature below 25° C. for crystal growth. Thus, the free molecules/colloids in the coating solution precursor can move slowly and aggregates into particulate crystalline grains, avoiding Brownian motion of the free molecules/colloids in a high-temperature crystal-growing environment. Thus, the possibility of generation of crystalline grains of larger diameters resulting from rapid aggregation of the crystalline grains due to rapid motion/impact between the free molecules/colloids is reduced. Furthermore, the impurities in the gel or external impurities can completely settle after a long period of time of steady placement. Thus, the crystal growing speed of the coating solution precursor can be effectively slowed down to reduce the possibility of generation of larger crystalline grains, obtaining the raw coating solution. In an example, the coating solution precursor is heated and stirred for 4-8 hours at a temperature of 70-80° C., fully dissolving the zinc acetate and the metal salt to obtain the gel. The coating solution precursor is then placed steadily in an environment of 5-23° C. for crystal growth. Control of the period of time for crystal growth lasts 3-30 days depending on the growth of crystalline grains in the coating solution precursor. After complete settling of the impurities in the gel and the external impurities, the raw coating solution can be obtained.

In the filtering step S3, the raw coating solution is filtered to obtain a coating solution. Specifically, after filtering the impurities in the gel and the external impurities settled at the bottom of the raw coating solution, a 0.5 μm mesh is used to filter the crystalline grains of a diameter larger than 0.5 μm suspending in the raw coating solution, obtaining a coating solution with particulate crystalline grains. Preferably, the coating solution is stored in an environment having a temperature of 5-23° C. before subsequent preparation of the transparent conductive film.

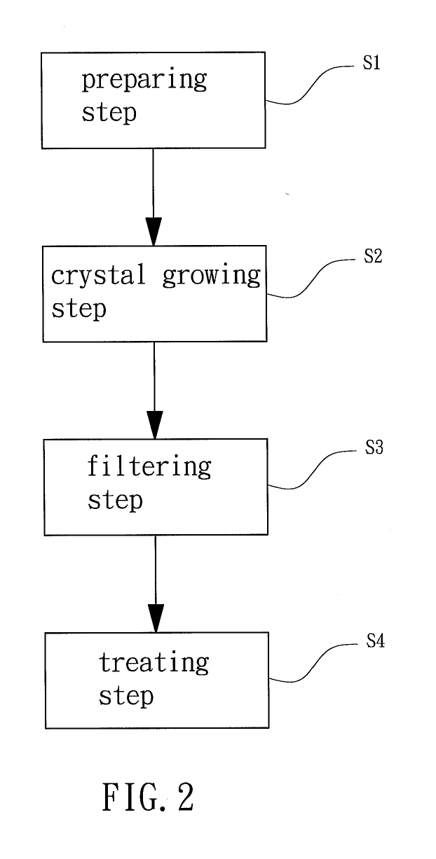

Furthermore, to further increase the stability of crystalline grains in the coating solution and to avoid residual large crystalline grains in the coating solution having a high concentration, a treating step S4 (see FIG. 2) can be carried out after the filtering step S3. After filtration of the raw coating solution in the filtering step S3, a substrate is submerged in the coating solution. After the substrate is fully submerged in the coating solution, the substrate is pulled out of the coating solution such that large crystalline grains and unstable crystalline grains can adhere to and then be removed from the surface of the substrate. Specifically, in the treating step S4, the substrate is operated at different temperatures (such as 16-18° C.) to proceed with submersion, pulling, adherence, discharge of solution, and evaporation in sequence, so that large crystalline grains and unstable crystalline grains or particulates adhered to the surface of the substrate while the surface of the substrate is being submerged can be removed from the surface of the substrate. Thus, the large crystalline grains and impurities residing in the coating solution can be effectively removed, increasing the stability of the crystalline grains in the coating solution. Thus, the transmittance of the transparent conductive film obtained from subsequent processing of the coating solution can be increased. In this embodiment, the treating step S4 is preferably dip-coating.

In the method for preparing a coating solution for producing a transparent conductive film according to the present invention, the crystal growth undergoes a period of long time in a temperature below the room temperature of 25° C. The steady placement of the coating solution precursor can be adjusted to be in a range of 3-30 days depending on the growth of the crystalline grains. Then, the impurities in the coating solution precursor and external impurities completely settle at the bottom of the coating solution precursor. Furthermore, by limiting the growing speed of the crystalline grains with the low temperature of 5-23° C., the free molecules/colloids in the coating solution precursor moves slowly. This avoids rapid movement/impact of the free molecules/colloids due to high temperature that may result in rapid aggregation of crystalline grains or particulates of larger diameters while the free molecules/colloids undergo Brownian motion. Thus, adverse affect to the quality of the coating solution precursor is avoided. Furthermore, after removal of the impurities in the gel and external impurities, by second removal of undesired crystalline grains from the coating solution through dip-coating, the residual large crystalline grains and unstable crystalline grains can adhere to the substrate and then be removed. Thus, the size of the crystalline grains remaining in the coating solution is uniform, avoiding adverse affect resulting from the large crystalline grains. Thus, the transparent conductive film produced from the coating solution has better transmittance to lights of various wavelengths.

Examples of preparation of coating solutions for transparent conductive films and subsequent tests of sheet resistance and transmittance of the transparent conductive films will now be described.

### Example 1

In example 1, zinc acetate was added into 2-propanol to form the first solution containing 0.75M zinc acetate, and aluminum nitrate was added into 2-propanol to form the second solution containing 1 wt % of aluminum nitrate. The first and second solutions were evenly mixed, and MEA was added as a stabilizer to form the coating solution precursor. The final concentration of MEA in the coating solution precursor was 0.75M. Next, the coating solution was heated and stirred for 4 hours at 75° C. The zinc acetate was completely dissolved and reacted with aluminum nitrate to generate a sol. The coating solution precursor was placed steadily for 3 days in an environment of 18-21° C. to undergo crystal growth and to form the raw coating solution. Finally, the impurities in the raw coating solution and external impurities settled at the bottom of the raw coating solution were removed, and a 0.5 μm mesh was used to filter crystalline grains with diameters larger than 0.5 μm in the raw coating solution, obtaining a coating solution for producing a transparent conductive film (see A1 in Table 1).

### Example 2

Example 2 was substantially the same as example 1 except that two stabilizers, such as MEA and DEA, or MEA and TEA, or DEA and TEA, were added before mixing of the first and second solutions. In this example, MEA and DEA were used as the stabilizers. The final concentration of MEA and DEA in the coating solution precursor was 0.75M. Subsequent procedures of example 2 were the same as those as example 1, obtaining a coating solution for producing a transparent conductive film (see A2 in Table 1).

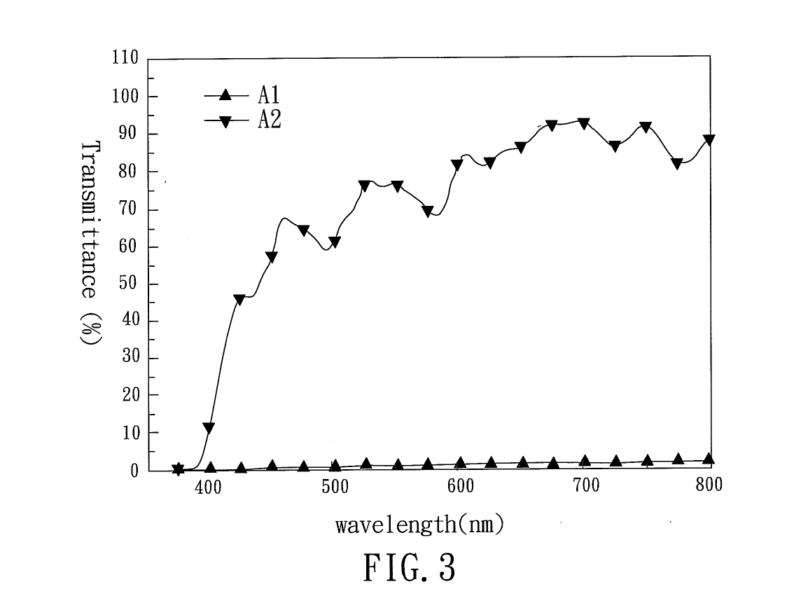

With reference to FIG. 3, the coating solutions obtained in examples 1 and 2 were used to produce transparent conductive films. In an example of dip-coating, substrates were repeatedly submerged into and pulled out of the two coating solutions (A1 and A2) at a speed of 360 mm/min. The substrates coated with the coating solutions (A1 and A2) were sintered at 500° C. for 2 hours. Then, the substrates were annealed at 500° C. for 2 hours in an environment containing 8% of hydrogen and 92% of nitrogen, obtaining transparent conductive films. Table 1 shows the test results of sheet resistance and transmittance carried out on the transparent conductive films.

TABLE 1

| | zinc | | | sheet | transmittance |
|---|---|---|---|---|---|
| | precursor/ | | | resistance | (%) |
| No. | solvent | metal salt | stabilizer | (Ω/□) | (at 550 mn) |
| A1 | zinc acetate/ | aluminum | MEA | 68.6 ± 3.4 | 0 |
| | 2-propanol | nitrate | 0.75M | | |
| | 0.75M | 1% | | | |
| A2 | zinc acetate/ | aluminum | MEA + DEA | 163.5 ± 7.8 | >60 |
| | 2-propanol | nitrate | 0.75M | | |
| | 0.75M | 1% | | | |

As can be seen from Table 1, the transparent conductive film produced from the coating solution using MEA and DEA as stabilizers has a transmittance above 60%, which has a better transmittance curve (FIG. 3) relative to lights of various wavelengths. Thus, the coating solution produced using two or more stabilizers during the low-temperature crystal growing procedure of the invention can efficiently control the crystal growing speed to reduce generation of difference sizes of crystalline grains, thereby increasing the transmittance of the transparent conductive film produced from the coating solution.

### Example 3

In example 3, zinc acetate was added into 2-propanol to form the first solution containing 1M of zinc acetate, and gallium nitrate was added into 2-propanol to form the second solution containing 4 wt % of gallium nitrate. The first and second solutions were evenly mixed, and MEA and DEA were added as stabilizers to form the coating solution precursor. The final concentration of MEA and DEA in the coating solution precursor was 1M. Next, the coating solution was heated and stirred for 4 hours at 75° C. The zinc acetate was completely dissolved and reacted with gallium nitrate to generate a sol. The coating solution precursor was placed steadily for 30 days in an environment of 18-21° C. to undergo crystal growth and to form the raw coating solution. Finally, the impurities in the raw coating solution and external impurities settled at the bottom of the raw coating solution were removed, and a 0.5 μm mesh was used to filter crystalline grains with diameters larger than 0.5 μm in the raw coating solution, obtaining the coating solution for producing a transparent conductive film (see B1 in Table 2).

### Example 4

Example 4 was substantially the same as example 3 except that after removal of the impurities in the raw coating solution and external impurities settled at bottom of the raw coating solution and filtration of crystalline grains with diameters larger than 0.5 μm from the raw coating solution, the treating step S4 was carried out to submerge a substrate in the coating solution to remove the large crystalline grains and unstable crystalline grains adhered to the substrate, obtaining a coating solution for producing a transparent conductive film (see B2 in Table 2).

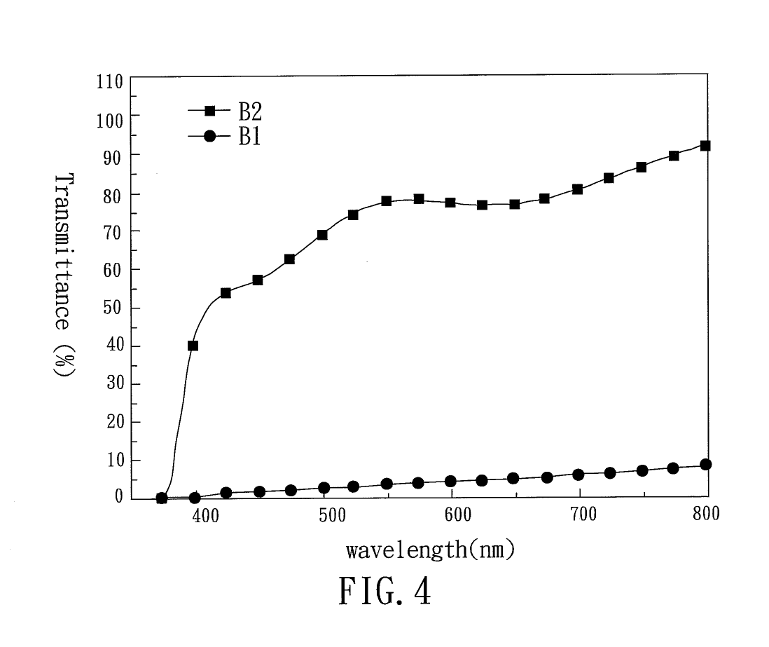

With reference to FIG. 4, coating solutions obtained in examples 3 and 4 were used to produce transparent conductive films. In an example of dip-coating, substrates were repeatedly submerged into and pulled out of the two coating solutions (B1 and B2) respectively at speeds of 300 mm/min and 150 mm/min (submersion/pulling was carried out 8 times for B1 and 12 times for B2). Subsequent steps identical to those for examples 1 and 2 were carried out to obtaining transparent conductive films. Table 2 shows the tests results of sheet resistance and transmittance carried out on the transparent conductive films.

TABLE 2

| | zinc | | | sheet | |
|---|---|---|---|---|---|
| | precursor/ | metal | | resistance | transmittance |
| No. | solvent | salt | stabilizer | (Ω/□) | (%) |
| B1 | zinc acetate/ | gallium | MEA + DEA | 442.1 ± 32.1 | 4 |
| | 2-propanol | nitrate | 1M | | |
| | 1M | 4% | | | |
| B2 | zinc acetate/ | gallium | MEA + DEA | 562.09 ± 40.93 | >80 |
| | 2-propanol | nitrate | 1M | | |
| | 1M | 4% | | | |

As can be seen from Table 2, the transparent conductive film produced from the coating solution subjected to the treating step S4 has a transmittance above 80%, which has a better transmittance curve (FIG. 4) relative to lights of various wavelengths. Thus, through long-term steady placement during the low-temperature crystal growing procedure and through the treating step S4 of dip-coating, the impurities in the coating solution precursor and the external impurities have a longer period of time to settle. Furthermore, the residual large crystalline grains in the coating solution can be removed in advance to effectively maintain the quality of the coating solution. Thus, the transparent conductive film produced from the coating solution has better transmittance.

The method for preparing a coating solution for preparing a transparent conductive film according to the present invention can control the crystal growing speed to reduce generation of difference sizes of crystalline grains, increasing the transmittance of the transparent conductive film produced from the coating solution.

The method for preparing a coating solution for preparing a transparent conductive film according to the present invention can completely remove large crystalline grains from the coating solution to maintain the quality of the coating solution, such that the transparent conductive film produced from the coating solution has better transmittance.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A method for preparing a coating solution for producing a transparent conductive film, comprising:
a preparing step including: dissolving a zinc precursor and a metal salt with a solvent to form a first solution containing the zinc precursor and a second solution containing the metal salt, mixing the first solution with the second solution, and adding at least one stabilizer into a mixture of the first and second solutions to form a coating solution precursor;
a crystal growing step including: heating and stirring the coating solution precursor until even dissolution of the zinc precursor and the metal salt, and steadily placing the heated and stirred coating solution precursor in an environment having a temperature lower than a room temperature to undergo crystal growth, obtaining a raw coating solution; and
a filtering step including: filtering the raw coating solution to obtain a coating solution.

2. The method for preparing a coating solution for producing a transparent conductive film as claimed in claim 1, further comprising a treating step after the filtering step, with the treating step including: submerging a substrate in the coating solution and pulling the substrate out of the coating solution after a surface of the substrate is coated with the coating solution.

3. The method for preparing a coating solution for producing a transparent conductive film as claimed in claim 1, wherein the temperature of the environment is in a range of 5-23° C.

4. The method for preparing a coating solution for producing a transparent conductive film as claimed in claim 1, wherein the coating solution precursor is steadily placed in the environment for 3-30 days in the crystal growing step.

5. The method for preparing a coating solution for producing a transparent conductive film as claimed in claim 1, wherein the raw coating solution is filtered with a 0.5 μm mesh in the filtering step to remove crystalline grains having diameters larger than 0.5 μm from the raw coating solution.

6. The method for preparing a coating solution for producing a transparent conductive film as claimed in claim 1, with the concentration of zinc precursor in the first solution being 0.1-1M, with the concentration of metal salt in the second solution being 0.1-10 wt %, with a final concentration of said at least one stabilizer in the coating solution precursor being 0.1-2M.

7. The method for preparing a coating solution for producing a transparent conductive film as claimed in claim 1, with said at least one stabilizer is selected from the group consisting of monoethanolamine, diethanolamine, triethanolamine, and combinations thereof.

8. The method for preparing a coating solution for producing a transparent conductive film as claimed in claim 1, wherein the zinc precursor is zinc acetate dehydrate or zinc acetate anhydrous.

9. The method for preparing a coating solution for producing a transparent conductive film as claimed in claim 1, wherein the metal salt is aluminum nitrate or gallium nitrate.

10. The method for preparing a coating solution for producing a transparent conductive film as claimed in claim 1, wherein the solvent is 2-propanol.
